(19) United States
(12) Patent Application Publication
(10) Pub. No.: US 2025/0326062 A1
(43) Pub. Date: Oct. 23, 2025

(54) LASER PROCESSING METHOD, LASER PROCESSING APPARATUS, LASER PROCESSING SYSTEM AND NON-TRANSITORY COMPUTER-READABLE STORAGE MEDIUM

(71) Applicant: MAKEBLOCK CO., LTD., Shenzhen (CN)

(72) Inventors: Honghua ZHANG, Shenzhen (CN); Jia LIU, Shenzhen (CN)

(21) Appl. No.: 19/185,534

(22) Filed: Apr. 22, 2025

(30) Foreign Application Priority Data
Apr. 23, 2024 (CN) 202410492317.5
Mar. 13, 2025 (CN) 202510299054.0

(51) Int. Cl. B23K 26/352; B23K 26/38

(52) U.S. Cl. CPC B23K 26/352; B23K 26/38

(57) ABSTRACT

A laser processing method, apparatus, and system thereof and a non-transitory computer-readable storage medium are provided in the present application relating to the field of laser processing technology. The method includes: acquiring a first image of a first region of a conveying device; filling a target processing pattern on the target processing material in the first image based on a reference processing material and a reference processing pattern thereon; performing laser processing on the target processing material by a laser processing apparatus; controlling the conveying device to move a preset distance for positioning a second region within a processing area; acquiring a second image and the target processing material positioned therein; and filling the target processing pattern on the target processing material in the second image and processing the target processing material located in the second region using the laser processing apparatus.

### CROSS REFERENCE TO RELATED APPLICATIONS

This application claims priority to China Application Serial No.202410492317.5, filed on Apr. 23, 2024, and China Application Serial No. 202510299054.0, filed on Mar. 13, 2025, the disclosures of which are incorporated herein by reference.

### FIELD OF DISCLOSURE

The present application relates to the field of laser processing technologies, and more particularly, some embodiments of the present application relate to a laser processing method, a laser processing apparatus, a laser processing system, and a non-transitory computer-readable storage medium.

### BACKGROUND

In the field of laser processing technology, batch processing can improve processing efficiency. Laser processing apparatuses, such as laser engraving and cutting machines, are widely used for marking, engraving, cutting, and other operations on various materials. Conventional laser processing systems with the laser processing apparatus typically utilize conveying devices, such as conveyor belts, to continuously transport materials into a processing range of the laser processing apparatus.

### SUMMARY OF DISCLOSURE

In a first aspect, the present application provides a laser processing method including following steps.
acquiring a first image of a first region of a conveying device;
filling a target processing pattern on a target processing material in the first image based on a reference processing material and a reference processing pattern formed on the reference processing material, and performing laser processing on the target processing material by a laser processing apparatus, wherein the target processing material is a processing material matched with the reference processing material;
controlling the conveying device to move a preset distance for positioning a second region of the conveying device within a processing area of the laser processing apparatus after the target processing material in the first region of the conveying device is machined; and
acquiring a second image of the second region of the conveying device, wherein the second image comprises the second region and the target processing material positioned in the second region and filling the target processing pattern on the target processing material in the second image, such that the target processing material located in the second region is machined by the laser processing apparatus.

In a second aspect, the present application provides a laser processing apparatus. The laser processing apparatus includes a processing head, a camera, and a controller.

The camera is configured to capture images of a processing area of the laser processing apparatus. The controller is configured to receive a processing command that is generated by the laser processing method recited in the first aspect, and to control the processing head to process a processing material located on the conveying device based on the processing command.

In a third aspect, the present application provides a laser processing system comprising: the laser processing apparatus;
the conveying device configured to carry and convey a processing material; and
a terminal device communicatively connected to the laser processing apparatus, wherein the conveying device is communicatively connected to the terminal device or the laser processing apparatus;
wherein the terminal device is configured to implement:
controlling the laser processing apparatus to acquire the first image of the first region of the conveying device;
filling a target processing pattern on a target processing material in the first image based on the reference processing material and the reference processing pattern formed on the reference processing material, and performing laser processing on the target processing material by the laser processing apparatus, wherein the target processing material is the processing material matched with the reference processing material;
controlling the conveying device to move the preset distance for positioning the second region of the conveying device within the processing area of the laser processing apparatus after the target processing material in the first region of the conveying device is machined;
controlling the laser processing apparatus to acquire the second image of the second region of the conveying device; and
filling the target processing pattern on the target processing material in the second image, such that the target processing material located in the second region is machined by the laser processing apparatus.

Optionally, in one embodiment of the present application, either the terminal device or the laser processing apparatus is implemented as an electronic device. The electronic device includes a memory, a processer, and a computer program stored on the memory and executable by the processor.

The computer program is configured to perform the steps of the laser processing method according to any one of embodiments recited foregoing.

In a fourth aspect, the present application provides a non-transitory computer-readable storage medium for storing computer program instructions, wherein the computer program instructions are executable by a processor of the computer to implement:
acquiring the first image of a first region of the conveying device;
filling a target processing pattern on the target processing material in the first image based on the reference processing material and the reference processing pattern formed on the reference processing material, and performing laser processing on the target processing material by the laser processing apparatus, wherein the target processing material is a processing material matched with the reference processing material;
controlling the conveying device to move the preset distance for positioning the second region of the conveying device within a processing area of the laser processing apparatus after the target processing material in the first region of the conveying device is machined;
acquiring the second image of the second region of the conveying device; and
filling the target processing pattern on the target processing material in the second image, such that the target processing material located in the second region is machined by the laser processing apparatus.

### BRIEF DESCRIPTION OF DRAWINGS

To more clearly illustrate the technical solutions in the embodiments of the present application, the drawings required for the description of the embodiments, or the related art are briefly introduced below. It is apparent that the drawings described below merely depict some embodiments of the present application. Other drawings may also be derived from the structures shown in these drawings by those skilled in the art.

FIG. 1 is a flowchart illustrating a laser processing method according to an embodiment of the present application.

FIG. 2 is a flowchart illustrating the laser processing method according to another embodiment of the present application.

FIG. 3 is a flowchart illustrating the laser processing method according to yet another embodiment of the present application.

FIG. 4 is a flowchart illustrating the laser processing method according to still another embodiment of the present application.

FIG. 5 is a flowchart illustrating the laser processing method according to further another embodiment of the present application.

FIG. 6 is a flowchart illustrating the laser processing method according to an additional embodiment of the present application.

FIG. 7 is a schematic diagram illustrating a processing operation of the laser processing method according to one embodiment of the present application.

FIG. 8 is a flow diagram illustrating a processing flow of the laser processing method according to one embodiment of the present application.

FIG. 9 is a block diagram illustrating a module of a laser processing system according to one embodiment of the present application.

FIG. 10 is a block diagram illustrating a module of the laser processing system according to another embodiment of the present application.

FIG. 11 is a schematic diagram illustrating the laser processing system according to yet another embodiment of the present application.

### DETAILED DESCRIPTION

Exemplary embodiments will now be described in detail with reference to the accompanying drawings. The objectives, functional features, and advantages of the present application will be further described in conjunction with the embodiments and with reference to the drawings. However, these embodiments can be implemented in various forms and should not be construed as limiting. Rather, they are provided to enhance the understanding of the present disclosure and to fully convey its concept to those skilled in the art. Furthermore, the specific embodiments described herein are for illustrative purposes only and do not limit the present application.

It should be noted that step reference numbers, such as S100 and S200, are used herein for the purpose of clearly and concisely describing corresponding content, and do not constitute substantive limitations on the order of execution. Those skilled in the art may execute S200 prior to S100 during specific implementations, and such variations shall fall within the scope of the present application.

In the field of laser processing technology, laser processing apparatuses can generally be categorized into two types. One type excludes a conveying device and places multiple processing materials within a single processing area for processing. After completion of each batch, a new batch of processing materials needs to be manually arranged, causing low processing efficiency.

Batch processing can effectively improve production efficiency in the field of laser processing. To achieve efficient batch processing, another type of laser processing system typically employs a conveying device to continuously deliver processing materials to the processing area of the laser processing apparatus for subsequent processing. However, in practical applications, some issues may still arise. For example, in a relatively large processing area, after completing one batch, it becomes necessary to manually arrange the next batch of processing materials and manually fill and form processing patterns for subsequent processing. Additionally, the processing materials on the conveying device are required to be aligned in the same direction and spaced at equal intervals. To satisfy these conditions, different conveying structures are produced for different types of processing materials, resulting in the need to use different conveying devices for engraving various materials, thereby causing high processing costs and inconvenient operation.

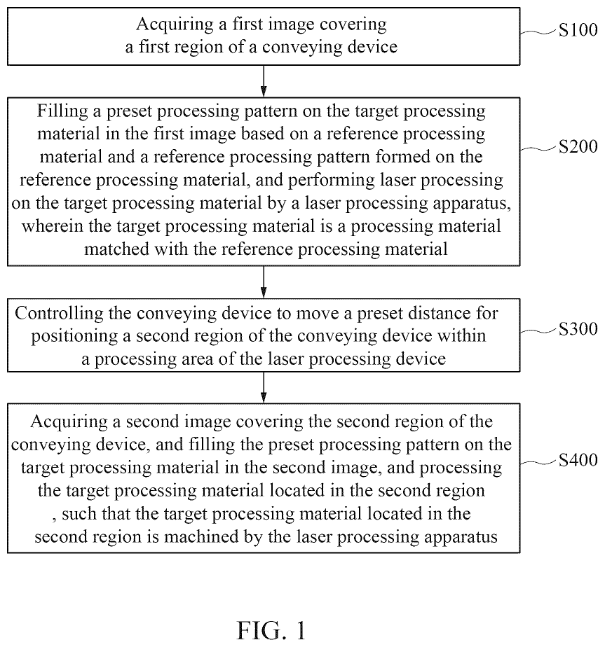

To address these above-mentioned issues, the present application provides a laser processing method. Referring to FIGS. 1 and 10, a laser processing method is provided according to an embodiment in the present application. The laser processing method includes the following steps:

Step S100: Acquiring a first image of a first region of a conveying device 100.

Step S200: Filling a target processing pattern on the target processing material in the first image based on a reference processing material and a reference processing pattern formed on the reference processing material and performing laser processing on the target processing material by a laser processing apparatus 300. The target processing material is a processing material matched with the reference processing material.

Step S300: Controlling the conveying device 100 to move a preset distance for positioning a second region of the conveying device 100 within a processing area of the laser processing apparatus 300, after the target processing material in the first region of the conveying device 100 is machined.

Step S400: Acquiring a second image of the second region of the conveying device 100, and filling the target processing pattern on the target processing material in the second image, such that the target processing material located in the second region is machined by the laser processing apparatus 300.

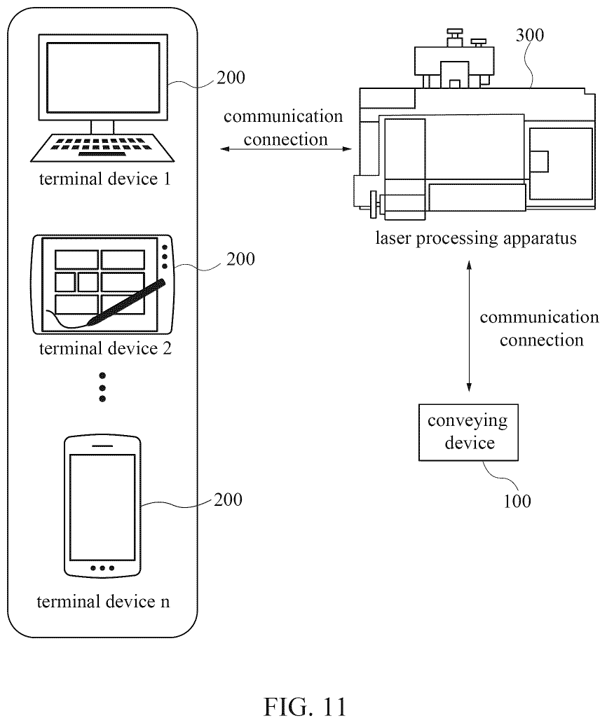

In this embodiment, in conjunction with FIG. 11, the laser processing method of the present application is applied by the laser processing apparatus 300 or a terminal device 200. For example, the terminal device 200 may integrate a memory configured to store a laser processing control program of the present application, and a processor configured to execute the laser processing control program. The processor may be implemented by a main controller, such as an MCU (Microcontroller Unit), DSP (Digital Signal Processor), FPGA (Field Programmable Gate Array), PLC (Programmable Logic Controller), SOC (System On Chip), or the like.

It should be noted that, in this embodiment, “filling” the target processing pattern onto the target processing material refers to virtually filling the processing patterns onto the image of the processing materials in the captured image. The filling operation is performed at the image level to define the processing pattern for subsequent laser processing.

Specifically, “filling” the processing patterns onto the processing materials refers to an operation performed at the image level, which may include actions such as mapping, overlaying, aligning, or embedding the target processing pattern onto the image of the processing material. Alternatively, the filling operation may involve adjusting the size, orientation, and position of the processing pattern relative to the corresponding processing materials in the image to ensure accurate definition of the processing pattern for subsequent laser processing.

It should be noted that, the target processing pattern refers to the processing pattern to be formed on the target processing material, and may correspond in position or content to the reference processing pattern. Notably, the target processing pattern formed on the target processing material and the reference processing pattern formed on the reference processing material may be identical or different. For example, in some embodiments, the target processing pattern and the reference processing pattern, respectively formed on the target processing material and the reference processing material located within the same region, may be identical in style and shape. In other embodiments, the target processing pattern and the reference processing pattern may differ in size and shape, while a relative positional relationship or a distribution of the target processing pattern on the target processing material remains consistent with a relative positional relationship or a distribution of the reference processing pattern on the reference processing material.

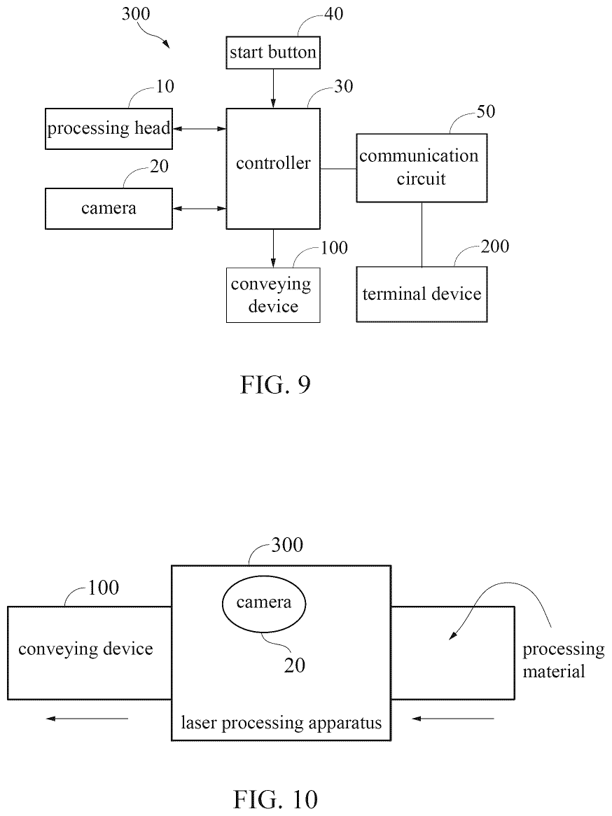

Referring to FIGS. 9 and 10, it can be understood that the laser processing apparatus 300 may include a laser marking machine, a laser engraving machine, a laser cutting machine, a laser welding machine, and the like. The terminal device 200 may include a computer, a smartphone, a tablet, and the like. The laser processing apparatus 300 can establish a connection with the terminal device 200 via a communication circuit 50, allowing a user to operate the terminal device 200 to control the laser processing apparatus 300, thereby improving operational convenience. The communication circuit 50 may be implemented using a wired communication module, such as a LIN (Local Interconnect Network) communication module, a CAN (Controller Area Network) communication module, an RS485 transceiver chip, and the like, and a corresponding bus type may be selected based on the communication module. Alternatively, the communication circuit 50 may be implemented using a wireless communication module, such as a WiFi module, a Bluetooth communication module, a 4G module, a 5G module, or the like.

It should be noted that, in laser processing technology, determining the position of the processing material is critical for accurately controlling a laser beam to perform processing. In this embodiment, a vision positioning system may be used. For example, the terminal device 200 may control a camera 20 of the laser processing apparatus 300 to capture the first image corresponding to the processing material located in the first region of the conveying device 100, and image processing software in a control device may be used to identify or mark the processing material, thereby accurately determining the position of the processing material on the conveying device 100. In some embodiments, the control device may be disposed in the laser processing apparatus 300 or the terminal device 200.

Optionally, a high-precision CCD (Charge-Coupled Device) camera may be installed on the laser processing apparatus 300 to capture the contour of the processing material or preset reference marks, thereby enabling dynamic adjustment of the position of a laser head of the laser processing apparatus 300. Optionally, before or during processing, a contact-type probe measuring instrument may be used to measure the geometric shape and position of the processing material and output a corresponding measurement signal to the control device, allowing the control device to control the position and orientation of the laser head based on the received measurement signal.

Optionally, after Step S200 and before Step S300, the laser processing method further comprises: controlling the laser processing apparatus 300 to perform laser processing on the target processing material located in the first region. Specifically, the target processing material in the first region may be processed based on the first image and the reference processing pattern positioned in the first image.

Optionally, the reference processing material is acquired through the following step: defining at least one processing material including a processing pattern as the reference processing material based on the first image.

Specifically, taking the example in which the terminal device 200 establishes a communication connection with the laser processing apparatus 300, after the terminal device 200 acquires the first image transmitted from the laser processing apparatus 300, a user may select any one of the processing materials in the first image as a reference processing material and place a pre-stored or pre-received processing pattern onto the selected reference processing material in the first image, thereby enabling the terminal device 200 to determine at least one processing material carrying the pre-stored or pre-received processing pattern as the reference processing material and then to fill the target processing pattern on the target processing material in the first image. Specifically, the processing pattern and the positions of multiple processing materials may be identified, thereby enabling determination of the processing material carrying the processing pattern as the reference processing material based on the processing pattern and the positions of the multiple processing materials.

It should be noted that, after completion of the filling of the target processing pattern, the terminal device 200 generates a corresponding processing file and sends the processing file to the laser processing apparatus 300 to control the laser processing apparatus 300 in performing laser processing on the corresponding target processing material positioned within the first region of the conveying device 100. For example, a user may preview the effect of the processing pattern on the actual processing material through software on the terminal device 200 and then save a working path or generate a processing program. Subsequently, the laser processing apparatus 300 is controlled to process the target processing material in the first region of the conveying device 100. After completing the processing of the target processing material in the first region, the terminal device 200 controls the conveying device 100 to move the preset distance, so that the conveying device 100 is positioned within the processing area of laser processing apparatus 300, and the camera 20 is then controlled to capture an image of the processing area to acquire the second image of the conveying device 100. The preset distance may correspond to a distance covering at least one processing area. Subsequently, the target processing pattern is filled on the target processing material in the second image, and the laser processing apparatus 300 is then controlled to perform laser processing on the target processing material located in the second region. Thus, batch laser processing of multiple processing materials located within the processing area is achieved.

It should be noted that, the position information of the processing material can be determined by acquiring the first image, the second image, and other images uploaded by the camera 20. For example, the actual position information of the processing material on the conveying device 100 can be calculated based on a mapping relationship between the image and the laser processing apparatus 300, and the working angle and direction of the laser head of the laser processing apparatus 300 can be controlled according to the actual position information, thereby controlling the laser processing apparatus 300 to process the processing material. Additionally, the physical position of the processing material can be converted into a coordinate system of the laser processing apparatus 300, thereby establishing a unified reference frame and determining the position of the processing material within the unified coordinate system to control the laser processing apparatus 300 to perform processing. Optionally, the actual position of the processing material can also be acquired in real time through a vision system, a contact probe, an optical sensor, an electromagnetic sensor, or the like, and fed back to the terminal device, so that the terminal device outputs a corresponding control signal to a controller 30 of the laser processing apparatus 300, thereby controlling the movement trajectory of the laser head. In addition, considering signal delays, when the first region or a subsequent region of the conveying device 100 enters the processing area of the laser processing apparatus 300, the camera 20 is controlled to capture an image and the conveying device 100 is controlled to stop moving to avoid positional shifts between the actual position of the processing material and the captured position information. This ensures the accuracy of the acquired position information as much as possible, thereby improving the processing effect and accuracy of the laser processing apparatus 300.

In practical applications, the camera 20 can capture images of multiple processing materials on the conveying device 100 to acquire position information of the processing material based on the captured images. A processing pattern to be engraved can be filled onto the target processing material on the image through corresponding software on the terminal device 200, and after completion of the filling, the reference processing material and the target processing material of the same type can be processed. In this manner, batch operations of first filling and then processing the target processing material located in different regions of the conveying device 100 can be achieved, thereby improving processing efficiency and operational convenience. Compared with the related art, the present application allows the user to arbitrarily place multiple processing materials on the conveying device 100. By using the laser processing method of the present application, images corresponding to the processing materials on the conveying device 100 can be acquired to acquire actual position information of the processing materials within the processing area. Manual calibration is not required, thereby achieving high precision and improving processing accuracy. This approach also addresses issues such as the requirement for the processing materials on the conveying device 100 to be aligned in the same direction and spaced at equal intervals, thereby improving processing efficiency. In addition, during the process of acquiring position information and controlling the laser processing apparatus 300 to perform processing, the conveying device 100 remains stationary, thereby eliminating concerns regarding positional deviations causing processing errors. Therefore, it is not necessary to provide different grooves or clamps with varying distances on the conveying device 100 to fix processing materials of different shapes. In other words, for different types of processing materials, it is not necessary to replace the conveying structure for adaptation, thereby reducing processing costs, improving operational convenience, and enhancing the user experience.

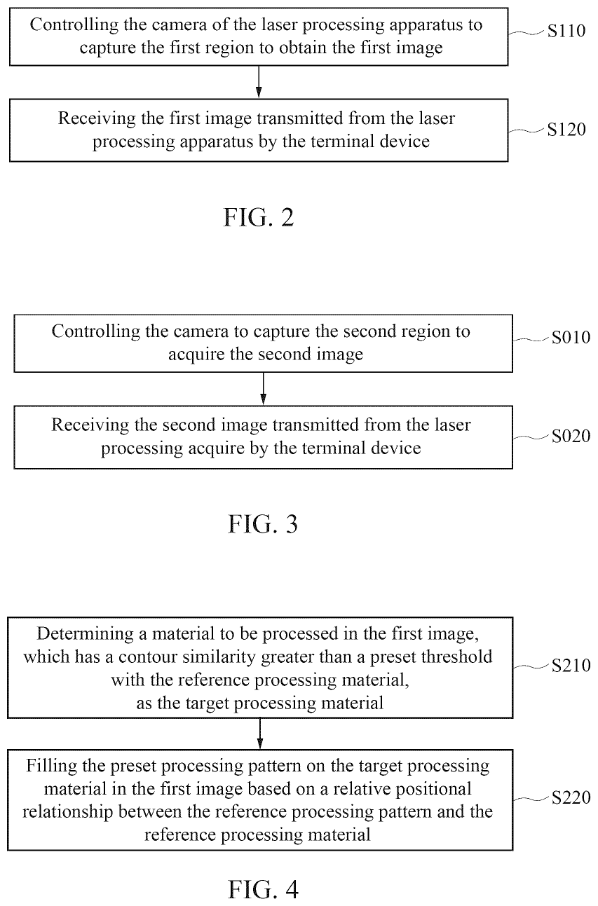

Referring to FIG. 2, in one embodiment of the present application, the step of acquiring the first image comprising the first region including the conveying device 100 disposed therein specifically comprises steps:

Step S110: controlling the camera 20 of the laser processing apparatus 300 to capture the first region to acquire the first image by the controller 30.

Step S120: receiving the first image transmitted from the laser processing apparatus 300 by the terminal device 200.

It can be understood that, in order to accurately acquire the actual position and dimensions of the processing material on the conveying device 100 and to achieve dynamic tracking and positioning, a vision system is typically installed in conjunction with the laser head of the laser processing apparatus 300. The camera 20 may be disposed adjacent to the laser head to coordinate with the laser head during operation. The camera 20 may be a CCD camera, an infrared camera, a line scan camera, an area array camera, a color camera, or a 3D camera, etc.

In this embodiment, the camera 20 is installed adjacent to the laser head of the laser processing apparatus 300 and is connected to a controller 30 of the laser processing apparatus 300. The controller 30 is configured to control the operating state of the camera 20, so that the camera 20 captures multiple processing materials on the conveying device 100 to acquire image information of the processing materials. For example, the camera 20 of the laser processing apparatus 300 may be controlled to capture the first region on the conveying device 100, and the laser processing apparatus 300 transmits the captured first image to the terminal device 200. The terminal device 200 receives the first image transmitted by the laser processing apparatus 300, allowing the user to fill the target processing pattern on the target processing material in the first image using related software on the terminal device 200. Specifically, when the control device acquires the first image captured by the camera 20, the first image is displayed as a background image in the software interface of the terminal device 200. That is, the user can directly edit a processing pattern on the first image through the terminal device 200 to complete the filling of the target processing pattern on the target processing material in the first image. For example, the user may place the target processing pattern, according to target processing parameters, onto any processing material on the editable background image, and designate the processing material with the filled processing pattern as the reference processing material. In this way, the terminal device 200 can fill the target processing pattern on the target processing material in the first image based on the reference processing material and the reference processing pattern filled thereon. The target processing parameters include the angular and positional relationship of the processing pattern on the processing material. In this way, the user can intuitively preview the effect of the processing pattern on the actual processing material through the terminal device 200. If the user finds that the position of the processing pattern edited according to the target processing parameters deviates significantly on the processing material, the user can directly adjust the target processing parameters through the terminal device 200 to modify the angular and positional relationship between the processing pattern and the processing material in the first image, thereby achieving an improved processing effect. In addition, after the camera 20 captures the image, the user can determine through the terminal device 200 whether the captured image is correct. If the image does not include complete image information of all the processing materials located under the laser head (within the processing area), it may be because some processing materials have not yet entered the processing area under the laser head or have not completely entered and are located at the edge of the processing area. In such cases, the user can operate the terminal device 200 according to the actual situation to output a corresponding control signal to the laser processing apparatus 300, so that the controller 30 of the laser processing apparatus 300 controls the conveying device 100 to move by a certain distance and controls the camera 20 to recapture the image. Consequently, it can be ensured that the position information acquired by the control device corresponds to all the processing materials within the processing area, thereby avoiding inconsistencies between the position information acquired from the image and the actual position information of the processing materials on the conveying device 100, which could otherwise lead to processing failures or processing materials not appearing in the image being omitted. As a result, the processing accuracy is improved.

It should be noted that the conveying device 100 and the laser processing apparatus 300 may be two separate devices, or the laser processing apparatus 300 and the conveying device 100 may be integrally configured, with the conveying device 100 being controlled by the controller 30 of the laser processing apparatus 300. When the conveying device 100 and the laser processing apparatus 300 are separate devices, the terminal device 200 may be communicatively connected to both the conveying device 100 and the laser processing apparatus 300. If the captured image does not include complete image information of all the processing materials within the processing area, the user can operate the terminal device 200 according to the actual situation to output a corresponding control signal to the conveying device 100 to control the conveying device 100 to move by the certain distance and to control the camera 20 to recapture the image.

In practical applications, by employing a vision system, the camera 20 is disposed at a preset position adjacent to the laser head to capture image information of the processing materials within the processing area of the laser processing apparatus 300, thereby improving the accuracy of the position information of the processing materials and enhancing processing efficiency and precision. Meanwhile, the terminal device 200 can fill the target processing pattern on the target processing material in the first image based on the reference processing material and the reference processing pattern filled thereon to facilitate subsequent processing operations. The user can also intuitively view the image information of the processing materials through the terminal device 200 and preview the processing effect of the processing pattern on the processing materials, thereby enabling timely adjustment of the target processing parameters to further improve the processing effect.

In one embodiment of the present application, referring to FIG. 3, the step of acquiring the second image including the conveying device 100 disposed therein specifically comprises steps:

Step S010: Controlling the camera 20 to capture the second region to acquire the second image.

Step S020: Receiving the second image transmitted from the laser processing apparatus 300 by the terminal device 200.

In combination with the above embodiments, after the processing materials in the first region are filled on the first image through the terminal device 200 and processed according to the filled processing patterns, the conveying device 100 is controlled to move by the preset distance, so that the second region on the conveying device 100 is positioned within the processing area of the laser processing apparatus 300. The terminal device 200 then controls the camera 20 of the laser processing apparatus 300 to capture the second image of the second region on the conveying device 100. The laser processing apparatus 300 transmits the captured second image to the terminal device 200, and the terminal device 200 receives the second image transmitted by the laser processing apparatus 300, allowing the user to fill a required processing pattern on the target processing material in the second image using the related software of the terminal device 200.

It can be understood that, after the laser processing apparatus 300 completes processing of the target processing material in the first region, the laser processing apparatus 300 can output a corresponding feedback signal to the terminal device 200 to report the completion status. Upon receiving the feedback signal and confirming that the processing is completed, the terminal device 200 outputs a corresponding control signal to the controller 30 of the laser processing apparatus 300 to control the conveying device 100 to move by the preset distance, so that when the next batch of processing materials (the processing materials in the second region) reaches the processing area of the laser processing apparatus 300, the conveying device 100 stops moving. The camera 20 can then capture the second image and upload the second image to the terminal device 200, facilitating processing of the target processing material in the second region by the laser processing apparatus 300.

The preset distance may correspond to the distance between the current batch of processing materials and the next batch of processing materials, or the distance between the previous batch and the current batch of processing materials. Since users can randomly place each batch of processing materials on the conveying device 100, the preset distance for moving the conveying device 100 during each batch processing may vary, or the preset distance may correspond to the length of the processing area of the laser processing apparatus 300. The camera 20 can automatically detect when each batch of processing materials enters the processing area, promptly capture an image, and upload the image to the terminal device 200.

Specifically, when the terminal device 200 acquires the second image captured by the camera 20, the second image is displayed as a background image in the software interface of the terminal device 200. The user can directly edit a processing pattern on the second image through the terminal device 200 to complete the filling of the target processing pattern on the target processing material in the second image. For example, the user may place the processing pattern, according to target processing parameters, onto any target processing material on the editable background image and designate the processing material with the filled processing pattern as the reference processing material. In this manner, the terminal device 200 can fill the target processing pattern on the target processing material in the second image based on the reference processing material and the reference processing pattern defined thereon, and, after the filling is completed, control the laser processing apparatus 300 to perform processing on the target processing material in the second region. Similarly, after completing the processing of the target processing material in the second region by the laser processing apparatus 300, the conveying device 100 is controlled to move by the preset distance so that a third region of the conveying device 100 is positioned within the processing area. The camera 20 is then controlled to capture an image of the third region to acquire a third image, and the third image is received to fill a corresponding processing pattern on the target processing material in the third image, thereby controlling the laser processing apparatus 300 to perform processing on the target processing material in the third region. This process is repeated until all the target processing materials in all regions on the conveying device 100 have been processed, or until a stop command triggered by the user is received, at which point the laser processing apparatus 300 stops processing.

It should be noted that when acquiring the reference processing material, the control device can separately calculate the relative positional information between the reference processing material and each of the remaining target processing materials, so as to acquire the position information of multiple target processing materials.

In this embodiment, referring to FIG. 9, after the terminal device 200 establishes a communication connection with the laser processing apparatus 300 via the communication circuit 50, the terminal device 200 outputs a corresponding control signal to the controller 30 of the laser processing apparatus 300, so that the controller 30 controls the operation of the camera 20 and receives the images transmitted by the laser processing apparatus 300. It can be understood that, referring to FIG. 10, when a user arbitrarily places multiple processing materials on the conveying device under the laser head of the laser processing apparatus 300, the image information captured by the camera 20 includes image information corresponding to the multiple processing materials. The user can select any one of the processing materials from among the multiple processing materials in the image as the reference processing material through the terminal device 200, so that the terminal device 200 can use the reference processing material as a basis to separately calculate the relative positional information between the reference processing material and each of the remaining target processing materials in the current editable background image. The actual position information of the processing materials on the conveying device 100 can then be calculated based on the mapping relationship between the image information and the laser processing apparatus 300. Subsequently, the working angle and direction of the laser head can be controlled according to the actual position information, thereby controlling the laser processing apparatus 300 to process the processing materials.

Specifically, when the terminal device 200 receives the image uploaded by the laser processing apparatus 300, the terminal device 200 can use the image captured by the camera 20 as an editable background image, allowing the user to intuitively perform corresponding edits on the background image. For example, a reference processing pattern can be placed onto the reference processing material. In this way, regardless of how many processing materials the user places, it is only necessary to select one processing material on the editable background image as the identification prototype. After the user edits the reference processing pattern onto the reference processing material, calculations can be performed based on the background image and the placement position of the processing pattern to acquire the angular and positional relationship between the reference processing pattern and the reference processing material, as well as the relative positional information between the reference processing material and the remaining target processing materials on the background image. Accordingly, the actual angle and position between the reference processing pattern and the corresponding reference processing material, and the actual relative position between the processing material corresponding to the reference processing material and the remaining target processing materials, can be determined. This allows the laser processing apparatus 300 to be controlled to perform processing based on the acquired positional information. The target processing pattern is predetermined by the developers. The relative positional information between the reference processing material and the remaining target processing materials calculated based on the image corresponds one-to-one with the relative positional information between the processing material corresponding to the reference processing material and the remaining target processing materials on the conveying device 100.

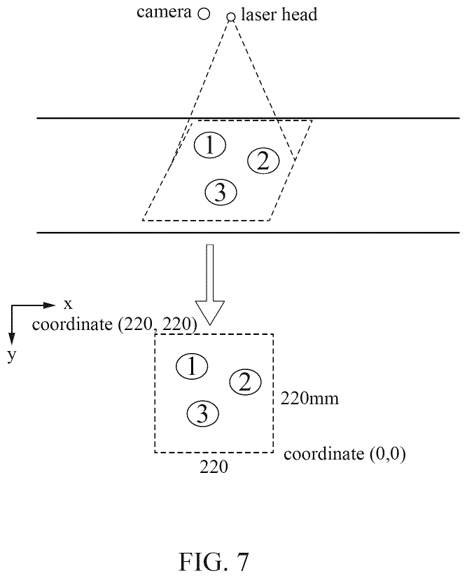

Referring to FIGS. 7 and 10, for example, when the processing area of the laser head is set to 220 mm×220 mm, it can be converted into a planar coordinate system from (X0, Y0) to (X220, Y220). Since the camera 20 is disposed at a preset position adjacent to the laser head, and the processing area of the laser head is located directly below the laser head, when the processing materials are conveyed into the processing area by the conveying device, the images captured by the camera 20 are actually tilted images relative to the laser head. Therefore, the terminal device 200 performs stretching, correction, and other processing on the images acquired by the camera 20 to convert them into a view directly beneath the laser head. The terminal device 200 then calculates a cropped view of 220 mm×220 mm based on the planar height between the laser head and the processing area on the conveying device 100, wherein the planar height between the laser head and the processing area is a fixed value. At this point, the position of each processing material on the background image corresponds to a specific position and area within the planar coordinate system. Accordingly, the actual position information of multiple processing materials can be acquired based on the images captured by the camera 20, facilitating the laser processing apparatus 300 to perform processing on the processing materials.

Through the above configuration, the laser processing method of the present application establishes a one-to-one correspondence between the image information acquired by the camera 20 and the actual position information of the processing materials. While accurately acquiring the actual positions of the processing materials on the conveying device 100, the user only needs to control the operating state of the camera 20 through the terminal device 200, without requiring additional operation steps, batch filling and processing operations for target processing materials across multiple processing regions are achieved, thereby improving the convenience of use for the user.

In one embodiment, the reference processing material comprises at least two types of processing materials, and the step of filling the target processing pattern on the target processing material in the first image based on the reference processing material and the reference processing pattern formed on the reference processing material comprises steps:

Filling at least two target processing patterns on the at least two target processing materials in the first image based on the at least two types of processing materials of the reference processing material and at least two reference processing patterns which are formed on the reference processing material. The at least two target processing materials are processing materials matched with the at least two types of processing materials of the reference processing material.

It should be noted that the same region of the conveying device 100 may include at least two types of processing materials, and the laser processing method of the present application can simultaneously process different types of processing materials.

In combination with the above embodiments, after the laser processing apparatus 300 controls the camera 20 to capture an image of the region of the conveying device 100 corresponding to the processing area of the laser processing apparatus 300, the terminal device 200 receives the image transmitted by the laser processing apparatus 300. When the captured image includes two types of processing materials, such as dog tags and business cards, respectively marked as type A and type B materials, the user can, through the software interface of the terminal device 200, select one dog tag as the reference processing material of type A on the editable background image and place a reference processing pattern (such as a pet's name) thereon, and select one business card as the reference processing material of type B and place a reference processing pattern (such as a company name) thereon.

The terminal device 200 fills corresponding target processing patterns for two types of target processing materials in the image based on the two reference processing materials and the reference processing patterns placed on the two reference processing materials. Specifically, the terminal device 200 fills a corresponding pet name on the target processing material matching the type A reference processing material based on the type A reference processing material and its reference processing pattern, and fills a corresponding company name on the target processing material matching the type B reference processing material based on the type B reference processing material and its reference processing pattern. After confirming the filling, the terminal device 200 generates a corresponding processing file and sends the processing file to the laser processing apparatus 300. The laser processing apparatus 300 processes all target processing materials (including dog tags and business cards) within the processing area sequentially based on the received processing file. After the processing is completed, the terminal device 200 sends a command to the controller 30 to control the conveying device 100 to move by the preset distance, so that the next region enters the processing area.

It should be noted that the processing materials placed on the conveying device 100 in the same batch may be identical. If the image information captured by the camera 20 includes at least two types of processing materials, when the user selects one processing material as the reference processing material, the terminal device 200 will fill target processing pattern only for the target processing material matching the reference processing material. After the filling is completed, the terminal device 200 transmits a corresponding processing file to the controller 30 of the laser processing apparatus 300 via the communication circuit 50, so that the controller 30 controls the laser head to process the target processing material matching the reference processing material.

The technical solution of the present application can simultaneously process multiple types of processing materials without the need to replace different conveying structures. By automatically identifying and classifying the processing materials, batch processing efficiency is greatly improved. The user only needs to select the reference processing material and place the reference processing pattern through the terminal device 200, and the terminal device 200 can automatically complete the filling of the target processing pattern and processing operations. In this manner, production efficiency and operational convenience are significantly enhanced.

In one embodiment, referring to FIG. 4, the step of filling the target processing pattern on the target processing material in the first image based on the reference processing material and the reference processing pattern formed on the reference processing material specifically includes:

Step S210: Determining a material to be processed in the first image, which has a contour similarity greater than a preset threshold with the reference processing material, as the target processing material.

Step S220: Filling the target processing pattern on the target processing material in the first image based on a relative positional relationship between the reference processing pattern and the reference processing material.

A pattern distribution of the target processing pattern on the target processing material corresponds identically to a pattern distribution of the reference processing pattern on the reference processing material.

In combination with the above embodiments, after the terminal device 200 receives the first image transmitted by the laser processing apparatus 300, the user can select the reference processing material on the first image through the software interface of the terminal device 200 and place a preselected processing pattern (e.g., the reference processing pattern) onto the corresponding position of the reference processing material. In this manner, the terminal device 200 can acquire the relative positional information between the processing pattern and the reference processing material, so that the processing pattern can be filled onto all processing materials in the first image that match the reference processing material. It should be noted that the terminal device 200 classifies processing materials in the first image whose contour similarity with the reference processing material is greater than a preset threshold as the target processing material matching the reference processing material. The terminal device 200 then fills the target processing pattern on the target processing material based on the relative positional relationship between the reference processing pattern and the reference processing material, so that the distribution of the reference processing pattern on the reference processing material is the same as the distribution of the target processing pattern on the target processing material. The preset threshold is predetermined by developers. For each processing material within the same processing area, the terminal device 200 calculates the contour similarity with the reference processing material. For example, if the preset threshold is 80%, only when the contour similarity of the processing material is greater than 80% will it be recognized as the target processing material.

It should be noted that the relative positional relationship includes one or more combinations of relative angle information and a coordinate relationship between a center point of the reference processing pattern and a center point of the reference processing material.

After identifying the reference processing material confirmed by the user and the placed reference processing pattern, optionally, the terminal device 200 calculates the relative angle information between the reference processing pattern and the reference processing material, so that the target processing pattern can be filled at the corresponding position on the target processing material. The relative angle information between the filled target processing pattern and the target processing material is the same as the relative angle information between the reference processing pattern and the reference processing material. Optionally, the terminal device 200 may calculate the coordinate relationship between a center point of reference the processing pattern and a center point of the reference processing material, and fill the target processing pattern at the corresponding position on the target processing material based on the coordinate relationship. The coordinate relationship between the center point of the filled target processing pattern and the center point of the target processing material is equal to the coordinate relationship between the center point of the reference processing pattern and the center point of the reference processing material.

Taking a dog tag as the target processing material, the relative positional relationship is described by taking the coordinate relationship between the center point of the reference processing pattern and the center point of the reference processing material as an example, the center point coordinates of each target processing material (dog tag) are first determined and then compared with the center point coordinates of the reference processing material. For example, if the center point of the reference processing pattern is positioned 2 millimeters to the right and 3 millimeters downward relative to the center point of the reference dog tag (the reference processing material), the terminal device 200 will determine the center point of the target processing pattern for another dog tag (the target processing material) by moving 2 millimeters to the right and 3 millimeters downward from the center point of that dog tag, thereby filling the target processing pattern for the dog tag.

Thus, not only is the processing accuracy improved, but manual intervention is also reduced, thereby ensuring consistency and reliability of the processing.

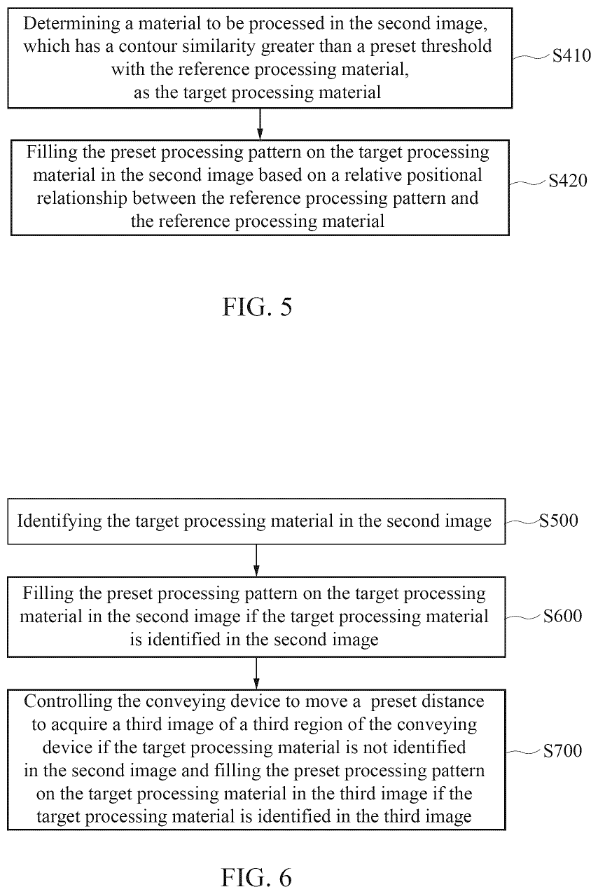

In one embodiment of the laser processing method, referring to FIGS. 5 and 10, the step of filling the target processing pattern on the target processing material in the second image based on the reference processing material and the reference processing pattern formed on the reference processing material includes:

Step S410: Determining a material to be processed in the second image, which has a contour similarity greater than a preset threshold with the reference processing material, as the target processing material.

Step S420: Filling the target processing pattern on the target processing material in the second image based on a relative positional relationship between the reference processing pattern and the reference processing material.

A pattern distribution of the target processing pattern on the target processing material corresponds identically to a pattern distribution of the reference processing pattern on the reference processing material.

In combination with the above embodiments, after the terminal device 200 receives the second image transmitted by the laser processing apparatus 300, the user can select the reference processing material on the second image through the software interface of the terminal device 200 and place a preselected processing pattern onto the corresponding position of the reference processing material. In this manner, the terminal device 200 can acquire the relative positional information between the reference processing pattern and the reference processing material, so that the processing pattern can be filled onto all processing materials in the second image that match the reference processing material. It should be noted that the terminal device 200 classifies processing materials in the second image whose contour similarity with the reference processing material is greater than the preset threshold as the target processing material matching the reference processing material. The terminal device 200 then fills the target processing pattern on the target processing material based on the relative positional relationship between the reference processing pattern and the reference processing material, so that the distribution of the reference processing pattern on the reference processing material is the same as the distribution of the target processing pattern on the target processing material. The preset threshold is predetermined by developers. For each processing material within the same processing area, the terminal device 200 calculates the contour similarity between the processing material and the reference processing material. For example, if the preset threshold is 80%, only when the contour similarity of the processing material is greater than 80% will it be recognized as the target processing material.

Taking a dog tag as the target processing material, the relative positional relationship is described by the angular information between the reference processing pattern and the reference processing material as an example, it is assumed that the pet name is rotated 15 degrees counterclockwise relative to the bottom edge of the reference circular dog tag. For each target processing material (i.e., other circular dog tags), regardless of their actual placement angles, the terminal device 200 adjusts the orientation of the pet name according to the preset relative angle of 15 degrees counterclockwise.

Thus, not only is the processing accuracy improved, but manual intervention is also reduced, thereby ensuring consistency and reliability of the processing.

In another embodiment of the laser processing method, the laser processing method further includes:

After filling the target processing pattern on the target processing material in the first image, generating a first processing file based on a positional information of the target processing pattern in the first image and a mapping relationship between the first region and the positional information and controlling the laser processing apparatus 300 to perform laser processing on the target processing material in the first region based on the first processing file; and/or

Subsequent filling the target processing pattern on the target processing material in the first image, generating a second processing file based on a positional information of the target processing pattern in the second image and a mapping relationship between the second region and the positional information and controlling the laser processing apparatus 300 to perform laser processing on the target processing material in the second region based on the second processing file.

Referring to FIGS. 9 and 10, in combination with the above embodiments, after the terminal device 200 fills the target processing pattern on the target processing material in the first image based on the reference processing material and the reference processing pattern formed thereon, the user can click “Start Processing” on the terminal device 200. The terminal device 200 then calculates the positional information of the reference processing pattern based on the first image and the placement position of the reference processing pattern, such as the angle and coordinates of the reference processing pattern relative to the reference processing material. Based on the calculated positional information of the reference processing pattern and the mapping relationship with the first region, the first processing file is generated, in which the actual physical position of the target processing pattern relative to the laser processing apparatus 300 is determined according to a preset mapping relationship and converted into a recognizable processing instruction. The first processing file is then transmitted to the laser processing apparatus 300. The laser processing apparatus 300 enters a processing-ready state and begins processing the target processing material only after the user presses the start button 40 (i.e., receiving a start command). It should be noted that the start button 40 needs to be pressed only for the first batch in batch processing, and subsequent processing does not require pressing the start button 40 again. After pressing the start button 40 and waiting for a short period, the laser processing apparatus 300 sequentially processes all the target processing materials in the first region based on the received first processing file. Upon completion, the user can randomly place additional processing materials of the same type at subsequent positions on the conveying device.

In this embodiment, after all the target processing materials in the first region have been processed, the terminal device can determine that the processing is complete based on a feedback signal transmitted by the laser processing apparatus 300, and send a command to the controller 30 to control the conveying device to move by the preset distance, thereby allowing the second region to enter the processing area of the laser processing apparatus 300. The controller 30 of the laser processing apparatus 300 again drives the camera 20 to capture the second region on the conveying device, acquires a second image, and uploads it to the terminal device. Upon receiving the second image, the terminal device 200 automatically fills corresponding target processing pattern for the target processing material in the second image based on the reference processing material selected by the user and the reference processing pattern placed on the reference processing material. Based on the positional information of the filled processing patterns and the mapping relationship between the second region and the positional information, the terminal device directly generates a second processing file without requiring a user command, transmits the second processing file to the laser processing apparatus 300, and controls the laser processing apparatus 300 to start processing directly without requiring confirmation by pressing the start button 40. For example, the terminal device determines the specific position of the processing pattern on each target processing material through an image processing algorithm and calculates the actual position of the processing pattern relative to the coordinate system of the laser processing apparatus 300. The positional information is then converted into machine-recognizable processing instructions, and a second processing file is generated and transmitted to the laser processing apparatus 300, so that the laser processing apparatus 300 can sequentially process all the target processing materials within the second region based on the received second processing file.

Through the above scheme, the positional information of the processing pattern is converted into machine-recognizable processing instructions based on a preset mapping relationship, thereby generating a processing file and ensuring the consistency and accuracy of the processing pattern. In addition, during the initial processing, the user is required to manually click the “Start Processing” button to confirm the initial settings, thereby reducing the likelihood of operational errors and improving the accuracy of the initial processing. Once the initial processing is started, the terminal device 200 can automatically carry out subsequent batch processing without requiring the start button 40 to be pressed again, thereby reducing the time of manual intervention and improving production efficiency.

In one embodiment of the laser processing method, referring to FIGS. 6 and 10, after the step of acquiring the second image of the second region of the conveying device, further includes:

Step S500: Identifying the target processing material in the second image.

Step S600: Filling the target processing pattern on the target processing material in the second image if the target processing material is identified in the second image.

Step S700: Controlling the conveying device 100 to move by the preset distance to acquire a third image of a third region of the conveying device 100 if the target processing material is not identified in the second image and filling the target processing pattern on the target processing material in the third image if the target processing material is identified in the third image.

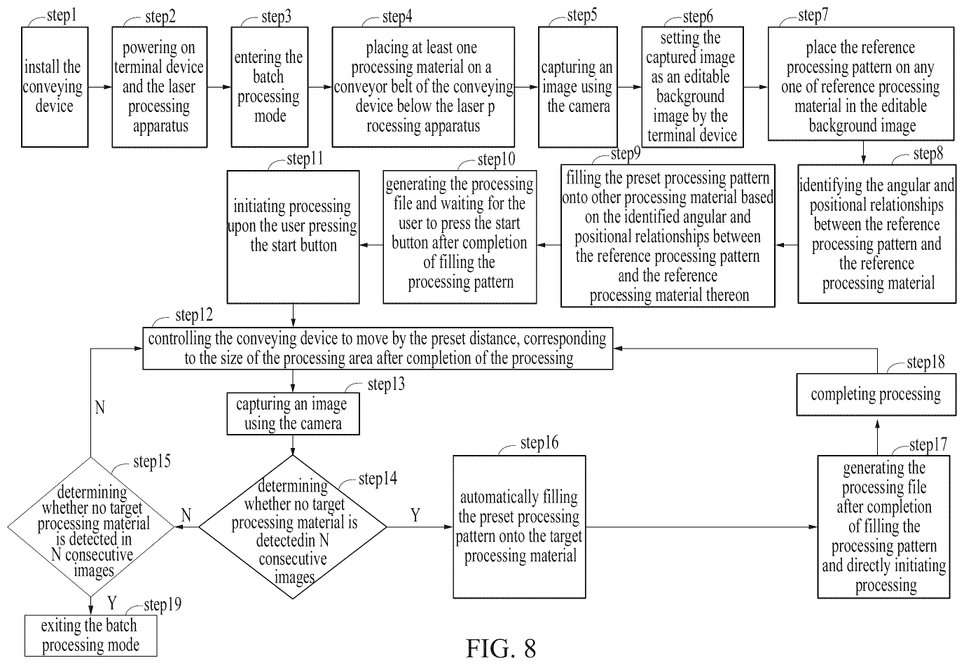

Referring to FIGS. 8, 9 and 10, before starting the processing, the user needs to install the conveying device 100, for example, by connecting the conveying device 100 to the laser processing apparatus 300 through a connecting cable. The terminal device 200 and the laser processing apparatus 300 are powered on, and software installed on an operating system such as Windows or iOS is launched. The terminal device 200 establishes a communication connection with the laser processing apparatus 300 through a USB cable or a Wi-Fi communication module. The user clicks to enter a batch processing mode through the terminal device 200, and the controller 30 of the laser processing apparatus 300 enables and powers the conveying device 100 by outputting a corresponding control signal to the conveying device 100 to control its operation. At this stage, the conveying device 100 remains stationary. At least one processing material is placed on a conveyor belt of the conveying device 100 below the laser processing apparatus 300. During initial processing, the terminal device 200 outputs a corresponding control signal to the controller 30 of the laser processing apparatus 300, enabling the controller 30 to control the camera 20 to capture an image of the processing material within the processing area, thereby acquiring the first image and uploading the first image to the terminal device 200. The terminal device 200 sets the captured image (e.g., the first image) as an editable background image by the terminal device 200. The user selects one processing material from among the processing materials in the editable background image as the reference processing material and places the reference processing pattern at a corresponding position on the reference processing material, thereby enabling the terminal device 200 to fill the reference processing material and recognize at least one processing material carrying the filled reference processing pattern as the reference processing material. The terminal device 200 then fills the target processing pattern on the target processing material in the first image based on the reference processing material and the reference processing pattern placed thereon.

To improve processing efficiency and accuracy, the user can intuitively edit the processing pattern and set processing parameters directly on the first image through the terminal device 200. After placing the desired reference processing pattern onto the reference processing material, and confirming that the reference processing pattern and its position are correct, the user clicks a processing command on the terminal device 200, thereby enabling the terminal device 200 to automatically fill the target processing pattern onto the another processing material selected as the target processing material in the first image. Upon completion of the filling, the user clicks “Start Processing” button 40 on the terminal device 200, thereby causing the processing file to be transmitted to the laser processing apparatus 300. Once the file transmission is completed, the laser processing apparatus 300 enters a processing-ready state, awaiting the user to press the start button 40 on the laser processing apparatus 300.

It should be noted that the start button 40 needs to be pressed only during the first batch of batch processing, and subsequent processing does not require pressing the start button 40 again. After the start button 40 is pressed and a short waiting period elapses, the processing is completed, and the user can then randomly place additional processing materials of the same type at subsequent positions on the conveying device 100. Specifically, after the processing is completed, the terminal device 200 sends a corresponding control command to the laser processing apparatus 300, enabling the laser processing apparatus 300 to control the conveying device 100 to move by the preset distance corresponding to the size of the processing area, such as the maximum area that can be processed directly beneath the laser head. The terminal device 200 then sends a control command to cause the controller 30 to control the camera 20 to capture the second image of the second region and transmit the image back to the terminal device 200 for processing. The terminal device 200 analyzes and processes the image to determine whether the target processing material is present in the second image, and if the target processing material is present, fills the target processing pattern on the target processing material in the second image.

It can be understood that, based on the reference processing material selected by the user, if the terminal device 200 does not identify any target processing material matching the reference processing material in the second image, the laser processing apparatus 300 may automatically exit the batch processing mode and perform individual processing on the reference processing material. Alternatively, the laser processing apparatus 300 may control the conveying device 100 to move by the preset distance to position the third region of the conveying device 100 within the processing area, and capture the third image of the third region on the conveying device 100. If the third image contains the target processing material matching the reference processing material, the target processing pattern is filled on the target processing material. If no matching target processing material is identified, the conveying device 100 continues to move by the preset distance until the target processing material matching the reference processing material is identified in a subsequently captured image, thereby facilitating the filling and processing operations for the target processing material.

In one embodiment, the laser processing method further includes:

Controlling the laser processing apparatus 300 to stop processing when the target processing material is not identified in a continuous sequence of N images or upon receiving a stop processing command.

To reduce unnecessary repeated operations, if no target processing material is identified in N consecutive images, that is, after the conveying device 100 has moved by the preset distance N times without identifying any target processing material in the Nth image, it is determined that the user is not present or there is no processing demand. In such a case, the laser processing apparatus 300 automatically exits the batch processing mode and be controlled to stop operation. The value of N is predetermined by developers. It should be noted that if no target processing material is identified in N consecutive images, or at any stage of the processing workflow, the user may manually exit the batch processing mode. Specifically, when the terminal device receives a stop command triggered by the user, it controls the laser processing apparatus 300 to stop processing. If it is necessary to process other types of processing materials, the user can also control the laser processing apparatus 300 to exit the batch processing mode, allowing the laser processing apparatus 300 to re-enter the batch processing mode for new operations.

In practical applications, the laser processing method of the present application requires the user to trigger the laser processing apparatus 300 during the initial processing, such as by pressing the start button 40 to confirm the start of processing, thereby effectively avoiding operational errors and potential safety hazards. In addition, the laser processing apparatus 300 is capable of automatically identifying whether the processing materials are of the same type and automatically filling processing patterns on the same type of processing materials, thereby improving processing efficiency. Furthermore, the image capturing and recognition process can be controlled separately from the processing operation, wherein the camera 20 first captures and recognizes the image, and then the laser head processes the target processing material located directly beneath it, thereby enhancing the reliability and accuracy of the laser processing apparatus 300. Moreover, when no target processing material is identified continuously, the laser processing apparatus 300 automatically exits the batch processing mode and is controlled to stop operation, thereby improving the safety of the laser processing and the convenience of user operations.

In an embodiment of the present application, an electronic device is provided. The electronic device includes a memory, a processer, and a computer program stored on the memory and executable by the processor. The computer program is configured to execute the steps of the laser processing method according to any one of the foregoing embodiments.

The electronic device may be the terminal device 200, the laser processing apparatus 300 (shown in FIG. 9, 10 or 11), or other related devices.

It should be noted that, since the electronic device of the present application is based on the above-described laser processing method, the embodiments of the electronic device encompass all technical solutions of the laser processing method, and the technical effects achieved thereby are completely identical, and thus will not be described in detail herein.

Referring to FIGS. 9 and 10, in one embodiment of the present application, a laser processing apparatus 300 is provided. The laser processing apparatus 300 includes a processing head 10, the camera 20 and the controller 30.

The camera 20 is configured to capture images of the processing area of the laser processing apparatus 300. The controller 30 is configured to receive a processing command generated by any one of the foregoing laser processing methods and to control the processing head 10 to perform processing on the target processing material located on the conveying device 100 based on the processing command.

In this embodiment, the controller 30 may be implemented using a main controller, such as an MCU, a DSP (Digital Signal Processor), an FPGA (Field Programmable Gate Array), a PLC, or an SOC (System on Chip). The processing head 10 may include a laser head, a cutting head, or similar components.

Referring to FIG. 9, in one embodiment of the present application, the laser processing apparatus 300 includes the controller 30, a button 40, the communication circuit 50, the processing head 10, and the camera 20.

The controller 30 is configured to control the camera 20 to capture images of the processing area to acquire images of any region of the conveying device 100 located within the processing area of the laser processing apparatus 300, including the first image, the second image, and so on.

Optionally, upon receiving the processing file transmitted by the terminal device 200, the controller 30 can parse the processing commands from the processing file and control the processing head 10 to process the processing materials within the processing area. Optionally, the laser processing apparatus 300 may also control the camera 20 to capture images and receive the images. After receiving the images, the user may determine the reference processing material and the reference processing pattern through a user input interface of the laser processing apparatus 300, allowing the laser processing apparatus 300 to fill the target processing patterns on the target processing material in the image based on the reference processing material and the reference processing pattern placed thereon. Upon completion of the filling, the processing file is automatically generated, and the processing head 10 is controlled to perform laser processing on the target processing material according to the processing file. In this way, participation of the terminal device 200 is not required, thereby improving the processing speed.

In one embodiment, optionally, when acquiring the first image of the first region of the conveying device 100, the controller 30 is configured to control the camera 20 of the laser processing apparatus 300 to capture the first region to acquire the first image and to receive the first image transmitted from the laser processing apparatus 300. The processing head 10 is configured to process a material within the first region to form the target processing pattern thereon.

Optionally, when acquiring the second image of the second region of the conveying device 100, the controller 30 is configured to control the camera 20 of the laser processing apparatus 300 to capture the second region to acquire the second image and to receive the second image transmitted from the laser processing apparatus 300. The processing head 10 is configured to process a material within the second region to form the target processing pattern thereon.

It should be noted that, since the laser processing apparatus 300 of the present application is based on the above-described laser processing method, the embodiments of the laser processing apparatus 300 encompass all the technical solutions of the laser processing method, and the technical effects achieved are completely the same, which will not be described again herein.

In another embodiment of the present application, a laser processing system is provided. The laser processing system includes any one of the foregoing conveying device 100 and the laser processing apparatus 300 described above. The conveying device 100 is configured to convey the processing material.

In this embodiment, the conveying device 100 may be implemented using a conveyor belt, a roller conveyor, a chain conveyor, rollers, flow rails, or other similar mechanisms. The laser processing apparatus 300 can employ the above-described laser processing method and automatically generate the processing file to control the processing head 10 (laser head) to perform laser processing on the target processing material.

Meanwhile, when the laser processing apparatus 300 determines that no target processing material matching the reference processing material exist in the captured image, or after completing processing of the target processing material corresponding to the current processing area, the laser processing apparatus 300 controls the conveying device 100 to move by the preset distance to convey a new processing material into the processing area, thereby enabling the laser processing apparatus 300 to control the camera 20 to capture a new image. The arrangement of the conveying device 100 enables continuous delivery of processing materials into the processing area of the laser processing apparatus 300, thereby achieving an uninterrupted processing flow. Thus, manual intervention time is reduced, and the processing efficiency of the entire production line is improved.

It should be noted that, since the laser processing system of the present application is based on the above-described laser processing apparatus 300, the embodiments of the laser processing system encompass all the technical solutions of the laser processing apparatus 300, and the technical effects achieved are completely the same, which will not be described again herein.

Referring to FIG. 11, in another embodiment of the present application, a laser processing system is provided. The laser processing system includes the laser processing apparatus 300, the conveying device 100 configured to convey the processing material and the terminal device 200.

The terminal device 200 is communicatively connected to the laser processing apparatus 100, and the conveying device 100 is communicatively connected to the terminal device 200 or the laser processing apparatus 300. The terminal device 200 is configured to control the conveying device 200 and the laser processing apparatus 300 based on the laser processing method according to any one of laser processing method mentioned foregoing to process the processing material located on the conveying device 100.

Upon receiving the first processing file and a start command, for example, upon receiving a command indicating that a start key has been triggered or upon detecting that a user has clicked a start button, the laser processing apparatus 300 performs laser processing on the target processing material positioned in the first region of the conveying device 100 based on the first processing file. The first processing file is generated based on the target processing pattern filled in the first image. Upon receiving the second processing file, the laser processing apparatus 300 performs laser processing on the target processing material located in the second region of the conveying device 100 based on the second processing file. The second processing file is generated based on the target processing pattern filled in the second image.

Specifically, when performing batch processing on multiple processing materials in the first processing region (e.g., the first region), the laser processing apparatus 300 is required to receive not only the processing file but also the start command input by the user before initiating batch processing. After completion of the first batch processing, when performing batch processing on multiple processing materials in a subsequent region (e.g., the second region or the third region), the laser processing apparatus 300 can directly proceed with the batch processing upon receiving the processing file without requiring further confirmation.

In this embodiment, the terminal device 200 includes at least one processor and a memory communicatively connected to the at least one processor. The memory stores a processing control program executable by the at least one processor. The processing control program is executed by at least one processor to enable at least one processor to perform the laser processing method according to any one of the foregoing embodiments.

In this embodiment of the present application, the terminal device 200 may include, but is not limited to, a mobile terminal such as a mobile phone, a laptop computer, a digital broadcast receiver, a personal digital assistant (PDA), a portable application device (PAD, e.g., a tablet computer), a portable media player (PM P), or a vehicle-mounted terminal (e.g., vehicle navigation terminal), as well as fixed terminals such as a digital TV or a desktop computer. The terminal device 200 and other computer devices illustrated in the present application are merely examples and are not intended to limit the functionality or scope of use of the embodiments of the present application.

The laser processing apparatus 300 may include, but is not limited to, a laser engraving machine, a laser cutting machine, a laser welding machine, or similar equipment. Optionally, the conveying device 100 may be communicatively connected to the terminal device 200, enabling the terminal device 200 to directly control the conveying device 100 to move when processing of the target processing material within the processing area is completed or when no target processing material matching the reference processing material is identified in the captured image, thereby conveying the next batch of processing materials into the processing area. Optionally, the conveying device 100 may be communicatively connected to the laser processing apparatus 300, enabling the terminal device 200 to output a control signal to the laser processing apparatus 300 upon determining that processing of the target processing material within the processing area has been completed or upon identifying that no target processing material matching the reference processing material is present in the captured image. In response, the controller 30 of the laser processing apparatus 300 controls the conveying device 100 to move, thereby conveying the next batch of target processing materials into the processing area to facilitate subsequent processing operations on the target processing material positioned on the conveying device 100.

In combination with the foregoing embodiments, after the terminal device 200 fills the target processing pattern on the target processing material in the first image based on the reference processing material and the reference processing pattern formed thereon, the terminal device 200 generates the first processing file based on positional information of the filled target processing pattern and a mapping relationship between the first region and the positional information, and transmits the first processing file to the laser processing apparatus 300. Upon receiving the first processing file, the laser processing apparatus 300 enters a processing-ready state. Upon receiving the start command triggered either by the user pressing the start button 40 on the laser processing apparatus 300 or terminal device 200 issuing a start command, the laser processing apparatus 300 processes the target processing material in the first region based on the first processing file.

After processing of the target processing material in the first region is completed, either the laser processing apparatus 300 or the terminal device 200 controls the conveying device 100 to move by the preset distance, thereby positioning the second region of the conveying device 100 within the processing area of the laser processing apparatus 300 and enabling the terminal device 200 to acquire the second image. If the target processing material matching the reference processing material is identified in the second image, the terminal device 200 fills the target processing pattern on the target processing material and, upon completion of the filling of the target processing pattern, automatically generates the second processing file and transmits the second processing file to the laser processing apparatus 300, thereby enabling the laser processing apparatus 300 to directly process the target processing material in the second region based on the received second processing file. If no target processing material matching the reference processing material is identified in the second image, the conveying device 100 continues to be controlled to move by the preset distance until another target processing material is identified in a subsequently acquired image, and the target processing material is processed according to the foregoing laser processing method. Alternatively, if no target processing material is identified in N consecutive images, or if a stop command is received, the laser processing apparatus 300 is controlled to stop processing and exit the batch processing mode.

The conveying device 100 may be communicatively connected to the terminal device 200 or the laser processing apparatus 300, thereby providing multiple control paths and achieving efficient automated operation.

Optionally, in one embodiment of the laser processing system, the reference processing material comprises at least two types of processing materials, and the step of filling the target processing pattern on the target processing material in the first image based on the reference processing material and the reference processing pattern formed on the reference processing material. The laser processing apparatus 300 is configured to fill at least two target processing patterns on the at least two target processing materials in the first image based on the at least two types of processing materials of the reference processing material and at least two reference processing patterns which are formed on the reference processing material. The at least two target processing materials are processing materials matched with the at least two types of processing materials of the reference processing material.

Optionally, in one embodiment, when filling the target processing pattern on the target processing material in the first image based on the reference processing material and the reference processing pattern formed on the reference processing material, the laser processing apparatus 300 is configured to determine a material to be processed in the first image, which has a contour similarity greater than a preset threshold with the reference processing material, as the target processing material and to fill the target processing pattern onto the target processing material in the first image based on a relative positional relationship between the reference processing pattern and the reference processing material. A pattern distribution of the target processing pattern on the target processing material identically corresponds to a pattern distribution of the reference processing pattern on the reference processing material.

It should be noted that, since the laser processing system of the present application is based on the foregoing laser processing apparatus 300, the embodiments of the laser processing system encompass all the technical solutions of the laser processing apparatus 300, and the technical effects achieved are completely the same, which will not be described again herein.

In one embodiment of the present application, the memory of the electronic device is a non-transitory storage medium. The non-transitory storage medium is a computer-readable storage medium and is configured to store the computer program. The computer program is configured to perform the steps of the laser processing method according to any one of the laser processing method according to any one of the foregoing embodiments.

The present application provides a non-transitory computer-readable storage medium for storing computer program instructions. The computer program instructions are executable by a processor of the computer to perform the steps of the laser processing method according to any one of the foregoing embodiments.

In one embodiment, the non-transitory computer-readable storage medium provided by the present application may be, for example, a USB flash drive, but is not limited to a system, device, or apparatus based on electrical, magnetic, optical, electromagnetic, infrared, or semiconductor technology, or any suitable combination thereof. More specific examples of the computer-readable storage medium may include, but are not limited to: an electrical connection having one or more wires, portable computer disks, hard disks, random access memory (RAM), read-only memory (ROM), erasable programmable read-only memory (EPROM) or flash memory, optical fibers, portable compact disc read-only memory (CD-ROM), optical storage devices, magnetic storage devices, or any suitable combination of the foregoing. In this embodiment, the computer-readable storage medium may be any tangible medium that contains or stores a program, which can be used by or in combination with an instruction execution system, apparatus, or device. The program code contained on the computer-readable storage medium may be transmitted via any appropriate medium, including but not limited to electrical wires, optical cables, radio frequency (RF) links, or any suitable combination thereof.

The above-mentioned computer-readable storage medium may be included within a computer device or may exist independently without being incorporated into the computer device. The computer-readable storage medium carries one or more programs, which, when executed by the computer device, cause the computer device to acquire the first image comprising a first region of the conveying device 100; fill the target processing pattern on the target processing material in the first image based on the reference processing material and the processing pattern formed on the reference processing material, so that the laser processing apparatus 300 performs laser processing on the target processing material located in the first region; after completing the processing of the target processing material in the first region, control the conveying device 100 to move by the preset distance so that the second region of the conveying device 100 is positioned within the processing area of the laser processing apparatus 300; and acquire the second image comprising the second region of the conveying device 100, fill the target processing pattern on the target processing material in the second image, and control the laser processing apparatus 300 to perform laser processing on the target processing material located in the second region.

The computer program code for performing the operations of the present application may be written in one or more programming languages or a combination thereof. The programming languages may include object-oriented programming languages, such as Java, Smalltalk, and C++, as well as conventional procedural programming languages, such as the “C” language or similar programming languages. The program code may be executed entirely on the user's computer, partially on the user's computer, as a stand-alone software package, partially on the user's computer and partially on a remote computer, or entirely on a remote computer or server. In the case of remote computers, the remote computer may be connected to the user's computer through any type of network, including a local area network (LAN) or a wide area network (WAN), or may be connected to an external computer (for example, through the Internet using an Internet Service Provider).

The flowcharts and block diagrams in the accompanying figures illustrate possible system architectures, functionalities, and operations for systems, methods, and computer program products according to various embodiments of the present application. In this regard, each block in the flowcharts or block diagrams may represent a module, program segment, or portion of code, which comprises one or more executable instructions for implementing specified logical functions. It should also be noted that, in some alternative implementations, the functions indicated in the blocks may be performed in an order different from that illustrated in the figures. For example, two blocks shown in succession may in fact be executed substantially concurrently, or the blocks may sometimes be executed in the reverse order, depending on the functionality involved. It should also be noted that each block in the block diagrams and/or flowcharts, and combinations of blocks in the block diagrams and/or flowcharts, can be implemented by a dedicated hardware-based system for performing the specified functions or operations, or by a combination of dedicated hardware and computer instructions.

The modules involved in the embodiments of the present application may be implemented in software or hardware. The names of the modules do not necessarily constitute limitations on the functions of the units themselves.

It should be noted that, since the storage medium of the present application is based on the above-described laser processing method, the embodiments of the storage medium of the present application encompass all technical solutions of the laser processing method described above, and the technical effects achieved are completely the same, which will not be described again herein.

The foregoing description is merely exemplary of optional embodiments of the present application and should not be construed as limiting the scope of the present application. Any equivalent modifications or transformations made under the inventive concept of the present application, based on the content disclosed in the specification and drawings, or any direct or indirect applications to other related technical fields, are intended to be included within the scope of protection of the present application.

What is claimed is:

1. A laser processing method, comprising the steps of:
acquiring a first image of a first region of a conveying device;
filling a target processing pattern on a target processing material in the first image based on a reference processing material and a reference processing pattern formed on the reference processing material, and performing laser processing on the target processing material by a laser processing apparatus, wherein the target processing material is a processing material matched with the reference processing material;
controlling the conveying device to move a preset distance for positioning a second region of the conveying device within a processing area of the laser processing apparatus after the target processing material in the first region of the conveying device is machined;
acquiring a second image of the second region of the conveying device; and
filling the target processing pattern on the target processing material in the second image, such that the target processing material located in the second region is machined by the laser processing apparatus.

2. The laser processing method according to claim 1, wherein the step of acquiring the first image of the first region of the conveying device, comprises:
controlling a camera of the laser processing apparatus to capture the first region to acquire the first image; and
receiving the first image transmitted from the laser processing apparatus.

3. The laser processing method according to claim 1, wherein the step of acquiring the second image of the second region of the conveying device, comprises:
controlling a camera of the laser processing apparatus to capture the second region to acquire the second image; and
receiving the second image transmitted from the laser processing apparatus.

4. The laser processing method according to claim 1, wherein the reference processing material comprises at least two types of processing materials, and the step of filling the target processing pattern on the target processing material in the first image based on the reference processing material and the reference processing pattern formed on the reference processing material comprises:
filling at least two target processing patterns on the at least two target processing materials in the first image based on the at least two types of processing materials of the reference processing material and at least two reference processing patterns which are formed on the reference processing material, wherein the at least two target processing materials are processing materials matched with the at least two types of processing materials of the reference processing material.

5. The laser processing method according to claim 1, wherein the reference processing material is acquired when at least one material to be processed, filled with the target processing pattern, is determined as the reference processing material based on the first image.

6. The laser processing method according to claim 1, wherein the step of filling the target processing pattern on the target processing material in the first image based on the reference processing material and the reference processing pattern formed on the reference processing material comprises:
determining a material to be processed in the first image, which has a contour similarity greater than a preset threshold with the reference processing material, as the target processing material; and
filling the target processing pattern onto the target processing material in the first image based on a relative positional relationship between the reference processing pattern and the reference processing material;
wherein a pattern distribution of the target processing pattern on the target processing material identically corresponds to a pattern distribution of the reference processing pattern on the reference processing material.

7. The laser processing method according to claim 6, wherein the relative positional relationship comprises one or more combinations of a relative angle information and a coordinate relationship between a center point of the reference processing pattern and a center point of the reference processing material.

8. The laser processing method according to claim 1, wherein the step of filling the target processing pattern on the target processing material in the second image, such that the target processing material located in the second region is machined by the laser processing apparatus, comprises:
determining a material to be processed in the second image, which has a contour similarity greater than a preset threshold with the reference processing material, as the target processing material; and
filling the target processing pattern on the target processing material in the second image based on a relative positional relationship between the reference processing pattern and the reference processing material;
wherein a pattern distribution of the target processing pattern on the target processing material corresponds identically to a pattern distribution of the reference processing pattern on the reference processing material.

9. The laser processing method according to claim 8, wherein the relative positional relationship comprises one or more combinations of a relative angle information and a coordinate relationship between a center point of the reference processing pattern and a center point of the reference processing material.

10. The laser processing method according to claim 1, after the step of filling the target processing pattern on the target processing material in the first image, further comprising:
generating a first processing file based on a positional information of the target processing pattern in the first image and a mapping relationship between the first region of the conveying device and the positional information; and
controlling the laser processing apparatus to perform laser processing on the target processing material in the first region based on the first processing file.

11. The laser processing method according to claim 1, after the step of filling the target processing pattern on the target processing material in the second image, further comprising:
generating a second processing file based on a positional information of the target processing pattern in the second image and a mapping relationship between the second region of the conveying device and the positional information; and
controlling the laser processing apparatus to perform laser processing on the target processing material in the second region based on the second processing file.

12. The laser processing method according to claim 1, after the step of acquiring the second image of the second region of the conveying device, further comprising:
identifying the target processing material in the second image;
filling the target processing pattern on the target processing material in the second image if the target processing material is identified in the second image;
controlling the conveying device to move a preset distance to acquire a third image of a third region of the conveying device if the target processing material is not identified in the second image; and
filling the target processing pattern on the target processing material in the third image if the target processing material is identified in the third image.

13. The laser processing method according to claim 12, further comprising:
controlling the laser processing apparatus to stop processing when the target processing material is not identified in a continuous sequence of N images; or
controlling the laser processing apparatus to stop processing upon receiving a stop processing command.

14. A laser processing apparatus, comprising:
a processing head;
a camera configured to capture images of a processing area of the laser processing device; and
a controller configured to receive a processing command that is generated by the laser processing method recited in the claim 1, and to control the processing head to process a processing material located on the conveying device based on the processing command.

15. The laser processing apparatus according to claim 14, wherein when acquiring the first image of the first region of the conveying device, the controller is further configured to:
control the camera to capture the first region to acquire the first image; and
control the processing head to process a material within the first region to form a target processing pattern thereon.

16. A laser processing system, comprising:
a laser processing apparatus;
a conveying device configured to carry and convey a processing material; and
a terminal device communicatively connected to the laser processing apparatus, wherein the conveying device is communicatively connected to the terminal device or the laser processing apparatus;
wherein the terminal device is configured to implement:
controlling the laser processing apparatus to acquire a first image of a first region of the conveying device;
filling a target processing pattern on a target processing material in the first image based on a reference processing material and a reference processing pattern formed on the reference processing material, and performing laser processing on the target processing material by the laser processing apparatus, wherein the target processing material is a processing material matched with the reference processing material;
controlling the conveying device to move a preset distance for positioning a second region of the conveying device within a processing area of the laser processing apparatus after the target processing material in the first region of the conveying device is machined;
controlling the laser processing apparatus to acquire a second image of the second region of the conveying device; and
filling the target processing pattern on the target processing material in the second image, such that the target processing material located in the second region is machined by the laser processing apparatus.

17. The laser processing system according to claim 16, wherein the laser processing apparatus is configured to perform laser processing on a target processing material based on a first processing file upon receiving the first processing file and a start command, the target processing material is located in a first region of the conveying device, and the first processing file is generated based on a target processing pattern filled in the first image; and
wherein the laser processing apparatus is further configured to perform laser processing on the target processing material located in a second region of the conveying device based on a second processing file upon receiving the second processing file, the second processing file is generated based on the target processing pattern filled in the second image.

18. The laser processing system according to claim 16, wherein the reference processing material comprises at least two types of processing materials, and the step of filling the target processing pattern on the target processing material in the first image based on the reference processing material and the reference processing pattern formed on the reference processing material, the laser processing apparatus is configured to:
fill at least two target processing patterns on the at least two target processing materials in the first image based on the at least two types of processing materials of the reference processing material and at least two reference processing patterns which are formed on the reference processing material, wherein the at least two target processing materials are processing materials matched with the at least two types of processing materials of the reference processing material.

19. The laser processing system according to claim 16, wherein when filling the target processing pattern on the target processing material in the first image based on the reference processing material and the reference processing pattern formed on the reference processing material, the laser processing apparatus is configured to:
determine a material to be processed in the first image, which has a contour similarity greater than a preset threshold with the reference processing material, as the target processing material; and
fill the target processing pattern onto the target processing material in the first image based on a relative positional relationship between the reference processing pattern and the reference processing material;
wherein a pattern distribution of the target processing pattern on the target processing material identically corresponds to a pattern distribution of the reference processing pattern on the reference processing material.

20. A non-transitory computer-readable storage medium for storing computer program instructions, wherein the computer program instructions are executable by a processor of the computer to implement:
acquiring a first image of a first region of a conveying device;
filling a target processing pattern on a target processing material in the first image based on a reference processing material and a reference processing pattern formed on the reference processing material, and performing laser processing on the target processing material by a laser processing apparatus, wherein the target processing material is a processing material matched with the reference processing material;
controlling the conveying device to move a preset distance for positioning a second region of the conveying device within a processing area of the laser processing apparatus after the target processing material in the first region of the conveying device is machined;
acquiring a second image of the second region of the conveying device; and
filling the target processing pattern on the target processing material in the second image, such that the target processing material located in the second region is machined by the laser processing apparatus.
